(19) United States
(12) Patent Application Publication
(10) Pub. No.: US 2002/0082954 A1
(43) Pub. Date: Jun. 27, 2002

(54) System and method for providing direct channel distribution over a global computer network

(76) Inventor: Stephen J. Dunston, Irving, TX (US)

Correspondence Address: MUNSCH, HARDT, KOPF & HARR, P.C., INTELLECTUAL PROPERTY DOCKET CLERK, 1445 ROSS AVENUE, SUITE 4000, DALLAS, TX, 75202-2790, US

(21) Appl. No.: 09/747,903

(22) Filed: Dec. 22, 2000

(51) Int. Cl. G06F 17/60

(52) U.S. Cl. 705/28

(57) ABSTRACT

A system and method for the sale and direct channel distribution of products and service over a global computer network, such as the Internet is provided.

### TECHNICAL FIELD OF THE INVENTION

The present invention relates generally to the field of direct channel distribution and in particular to creating a system technique and software for a business model that would allow a company to compete in an e-commerce worldwide marketplace. BACKGROUND OF THE INVENTION

Bypassing distributors, middlemen and retailers typically means more money for the business that is manufacturing or selling a product. However, a business must have the structure in place to support sales directly to customers. Therefore, businesses that sell directly to consumers typically limit their sales activities to certain geographical areas in which they can provide adequate resources.

With the advent of the Internet, the potential market for direct sales has vastly increased. Information about a business' products can be easily made immediately available to potential customers all across the world. Indeed, businesses are receiving unsolicited inquiries and purchase orders from all over the world, causing them to open their eyes to the potential of new markets. Because many businesses do not have the resources that are necessary to support direct sales of their particular products all over the world, they are passing up many present sales opportunities.

Furthermore, establishing direct distribution and sales resources in remote areas is expensive and takes time. For many of these businesses, it may not be prudent to risk the amounts of money necessary to expand operations into these areas. For example, finding, leasing and/or building warehouses to store products is expensive. Warehouse staff have to be hired to operate the warehouse. Personnel may be needed to act as sales representatives, to take orders and to solve problems with customers. And there are logistical problems and costs associated with maintaining and tracking inventory in a remote location.

### SUMMARY OF THE INVENTION

The invention addresses one or more problems associated with establishing direct distribution and sales channels using a shared direct channel distribution system that permits a business to expand distribution of its products on an incremental, variable cost basis. Efficiency of use of the distribution system can be increased by sharing resources. In a preferred embodiment a sales and distribution system embodying the invention creates a network of hubs in an outsourcing services organization to meet the needs of a business as described above.

A preferred embodiment of the invention, as defined by the appended claims, is described below with reference to an example of direct distribution and sales system deploying the invention.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a schematic diagram of a preferred embodiment system for providing direct channel distribution;

FIG. 2 is a schematic block diagram of a preferred embodiment web server;

FIG. 3 is a schematic block diagram of a preferred embodiment server;

FIG. 4 shows a flowchart for the preferred embodiment method for processing an order request; and

FIG. 5 is a schematic block diagram illustrating a plurality of geographically distributed hubs.

### DETAILED DESCRIPTION OF THE DRAWINGS

This system has several inventive aspects, which possess individually and collectively certain advantages described below. With this system, a business, such as a manufacturer, a supplier, a reseller and/or the like, may ship products directly from a production line preferably to the nearest distribution network hub which serves as the base hub providing direct networked contact with other hubs in those locations in which the business seeks to sell and distribute its products. It is contemplated that this hub is shared, meaning that the hub is used by more than one business to distribute products. The hub may also serve as the base hub for more than one business. The hub includes a storage facility or warehouse which may be under the control of the business. The business may outsource the control of the warehouse to an outsourcing company, if desired. Distribution and/or sales services related to distribution of the products from this hub are provided to the business on a variable cost basis. A software system is used to manage the shared direct distribution and sales system, and to allow client/user businesses to manage their products within the system. The software system may be a suite of software systems designed to work in concert. The system thus provides direct channel sales and/or distribution services, worldwide, using a network of facilities to serve businesses on an outsourced basis. It provides all those services needed to act, in an outsourcing mode, as a complete branch office, sales and distribution facility for a business, at lower costs, than the businesses could establish such facilities and do the work themselves.

By using the example described below in reference to the appended drawings, a direct channel sales, service support and/or distribution system may be implemented using a global public data network such as the Internet to provide outsourcing facilities using a common software system. Following is an overview of the principles underlying such a system.

The system may be used to implement “just in time” distribution services, which offer the option to a business to send products directly from a production line into shipping trailers that carry those products directly to a shared distribution network hub. Typically, this network distribution hub will be the nearest facility and it will function as the client/user's base hub for feeding the rest of the worldwide distribution network. With “just in time” distribution, a manufacturer, for example, could use its existing facilities for production rather than warehouse space, thereby increasing its ability to meet demand for products at reduced cost compared to what it would have otherwise incurred.

By careful selection of market areas and locating the shared hubs in the selected areas, a client/user business entity using the system will be able to quickly expand its market to almost any part of the world when it chooses. It can expand all at once picking several locations or “ramp up” more slowly, adding one facility at a time. These shared distribution hubs act as the client/user's “branch(es)”. Additional services may be offered at each hub on a variable cost basis for both facilities and labor at each location.

In the preferred embodiment, the system's software components include a distribution tracking component for tracking use of facilities and products in those facilities, an efficient warehouse and pick/pack/ship management system and a services tracking component for tracking use of labor and other services charged on a time or task basis. A fourth component to the software system allows a client/user to manage remotely these services, for example, inventory at all of the hubs, using a standard Web browser or other standards-based viewing or information transfer tool. The combination of these components permits establishment of a direct channel distribution system with variable costs. These variable costs are determined on the basis of the amount of materials held in each hub and the amount of each type of work actually performed in connection with distribution and sales services during a period of time. Such a system permits businesses that are beginning to get into direct channel distribution to ramp-up operations without substantial up-front investment.

The distribution tracking component of the software system is used to manage direct channel distribution services. Preferably, it is a scalable, client-server based system and is capable of managing multiple distribution locations, for example warehouses, using the Internet as a networking and reporting tool. The distribution system tracks the products and materials actually stored in warehouse facility at each hub for its multiple client/users. It further optimizes the use of the space in a building based on each client/user's actual storage needs, while maintaining control of SKUs or other product identification codes by location within a single warehouse or throughout a network of warehouses. Rather than subdividing the warehouse into areas which would effectively lease a fixed amount of space to a business entity, a warehouse space at a shared distribution hub is subdivided based on a much smaller measurement unit. Thus, use of the storage can be optimized and storage can be charged periodically, such as on a monthly basis, based on the space, or other type of storage actually used. The client/user may choose to have as many or as few items at any one location as meets that specific market's needs, thereby keeping costs and overall inventory to a minimum. Different measurement or storage units could be utilized depending on the type of products or materials that are stored, for example pallets for larger items, shelving units for smaller items. Even bulk chemical containers could be used as a storage measurement unit for chemicals. A single storage facility could use multiple different storage units, depending on the needs of its client/users.

The distribution tracking component is also used to collect product storage information from other hubs and aggregate it in a single location. A client/user could also use the distribution component to track its own inventory and aggregate it with information from the shared hubs.

As previously noted, the distribution component includes management tools for picking, quick assembly, packing and shipping work required to fulfill orders efficiently. The setup of each distribution location is preferably organized in the same manner. Each uses the same system for numbering pallet and shelving unit positions in the warehouse. The system uses a continuous number sequence, in a snake like pattern up and down the aisles, creating a one-way traffic pattern within the aisles. This allows many pickers to be used at the same time without congestion. The one-way passage applies only within the aisles between the racks and shelving units. At both ends of the storage area there are two-way aisles, which allow a picker to move directly to a specific aisle so long as when entering the aisle the picker is moving in the correct one-way direction. This method allows for an efficient system for random storage of materials for multiple client/users in a single facility. It also offers efficiencies in picking for fulfillment operations.

Picking operations for order fulfillment are consolidated so that many orders for a client/user can be picked together in bulk in one pass through the warehouse. The picker is given a consolidated pick sheet with items in location number order from lowest to highest with all the individual orders that he or she is directed to pick consolidated into total bulk counts for each item. The picker may use a rolling cart or other equipment on which picked products or materials may be placed and easily transported. For example, a rolling cart with multiple shelves may be used. As the picker reaches the correct location to pick the first item, that item is placed on the right of the top shelf of the rolling cart. The next item picked and placed to the left of the previous item, and so on until the top shelf is filled. Then the picker begins to place the next item on the right of the second shelf, the following item placed to the left of the first on that shelf. And this continues until all items on the pick sheet have been picked or the cart is filled, at which point the picker will get another rolling cart to complete that pick sheet. If a third cart is needed for that same pick sheet the picker will use same, and a fourth, and a fifth, etc. When the pick sheet is completed the picker delivers the cart or carts to a packer at a packing station, at which products for each order are packed.

When a picker delivers the carts to a packer, the cart or carts serve as a staging system for packing the orders. It is the result of the fact that the consolidation and all the orders that accompany it show all items in the same location sequence. By putting the items on the carts using the orderly technique explained above, the packing process is expedited and has less room for error. Furthermore, using this picking system, materials are actually counted twice: once in bulk by the picker and then again by the packer when assembling the individual orders for shipment. This contributes to accuracy in fulfilling orders.

A global computer network, such as the Internet, can be used to connect to one or more public or private carriers to track shipments, determine delivery times, and/or provide proof of delivery, such as copies of signatures, to designated representatives. Customer service can be greatly enhanced in this manner.

The services tracking component keeps track of the costs for labor performed for each client/user. It tracks the time required to perform a task. Each task may be assigned a specific rate different from other tasks, based on actual costs associated with that task. Time may be entered on hand-held computers. These computers could also be used to track orders that are to be picked. The services tracking component may also, in addition to tracking labor, track the use of equipment. The value of the services is charged to a client/user of the system based on time spent on a task, multiplied by a task rate. Alternately, a flat rate per task could be charged. A billing component generates, such as on a periodic basis, invoices for the work actually performed. Thus, a client/user business that has only a few minutes of productive work performed at any one location on any given day will only pay for those few minutes of time, while if there is a lot more activity the following day the client/user will pay, only for the minutes used on both days. The system thus offers a client/user completely variable labor/work costs for each day at known rates. The client/user pays only for the amount of labor/work required to service the needs of its business.

An order entry component may also be included with the system. The order entry component may receive orders over the Internet or similar public network, as well as through more conventional means by which orders are received and entered, such as by manual entry of an order received via telephone, facsimile or mail. The distribution and inventory systems offer tight controls with each item being deducted from stock at a specific designated location as each item is entered into the system. If any item is out of stock or has reached a low stock notification point, a notice of the status is given as the item is entered. In addition the system provides for many other online customer services and order tracking functions for prompt information about the status of any shipment.

To accommodate facilities in countries with different customs and using a different language and currency, the front-end of the system's software may be “localized” in its outward appearance, with the display being in a language and currency of the country in which the hub facility is located. Even though the front-end may be localized, this software system retains basic elements of functionality, wherever located, so that a business making use of it can manage the direct channel sales and distribution of the business' products around the world using a computer at the business' home location. Furthermore, the rates for services at each hub location, wherever in the world, may be developed in the currency used and at the costs for labor and equipment in that area.

The software system connects multiple locations using servers that may have their own unique localized “front end” or interface characteristics. Even though the system may be localized on the front end to handle most language, currency and cultural differences in markets, the basic system for managing the business remains unchanged, allowing universal control by the client/user from a few different offices or a single headquarters location.

If desired, the localized front end can be further customized to include a sales presentation. This sales presentation can be made to a customer or potential customer of a client/user logging onto the server. Such sales presentation may include for example product information or advertisements preferably in the local language and take into account the cultural differences in different markets. Such information and/or advertisement can be presented to the customer in the form of text, audio, video and/or the like. An advantage of such a system is that a client/user can outsource both the distribution and the sales/marketing effort to an outside agency. Moreover, by localizing the front end depending on different markets the customer base can be better targeted.

Another component of the software system is a client/user management component that can be used by a client/user to control its own direct channel distribution business worldwide using the shared resources and facilities of the present system. The client/user management component retrieves information on a client/user's inventory at each hub in the shared distribution and sales system, from the distribution component and makes it available upon request via a standard service or application such as a Web browser over a public network such as the Internet. With this information a business may decide how much inventory to keep in any location at any time, and monitor inventories in all locations to give instructions to move products from location to location as needed.

The software system may also use the Internet or similar public network having open or widely adopted standards to communicate with information sites of public carriers to track shipments, determine delivery times and provide copies of signatures for proof of delivery almost instantly.

The preferred embodiment system is scalable so that new warehouses and/or hubs may be added to an existing network or warehouses and/or hubs removed from the existing network without the expenditure of substantial resources. The system manages multiple warehouses using a global computer network, such as the Internet, as a warehouse networking and reporting tool. The system allows storage of materials for multiple business entities at one or more warehouses while maintaining a detailed record of the different materials at a single location or at multiple locations. Moreover, it is not necessary that the system be used in isolation to manage the entire warehouse. In alternative embodiments, the system can be used with other systems in the same warehouse to manage a portion of the warehouse. Thus, if a client/user business entity is sharing a warehouse with others, the particular client/user business entity may decide to use the present invention to manage its inventory in the warehouse while the other business entities may continue to manage their inventory in a manner of their choice.

The system is capable of receiving orders from customers of business entities over the Internet as well as the conventional means by which orders are received and entered. Thus, existing inventory management systems can be interfaced with the system and method of the present invention. The inventory portion of the system keeps track of the inventory with each item being deducted from stock at a specific designated location as each item is being entered at the order entry terminal. The order entry terminal could access the system locally over a direct cable connection or from any location in the world having access to the Internet.

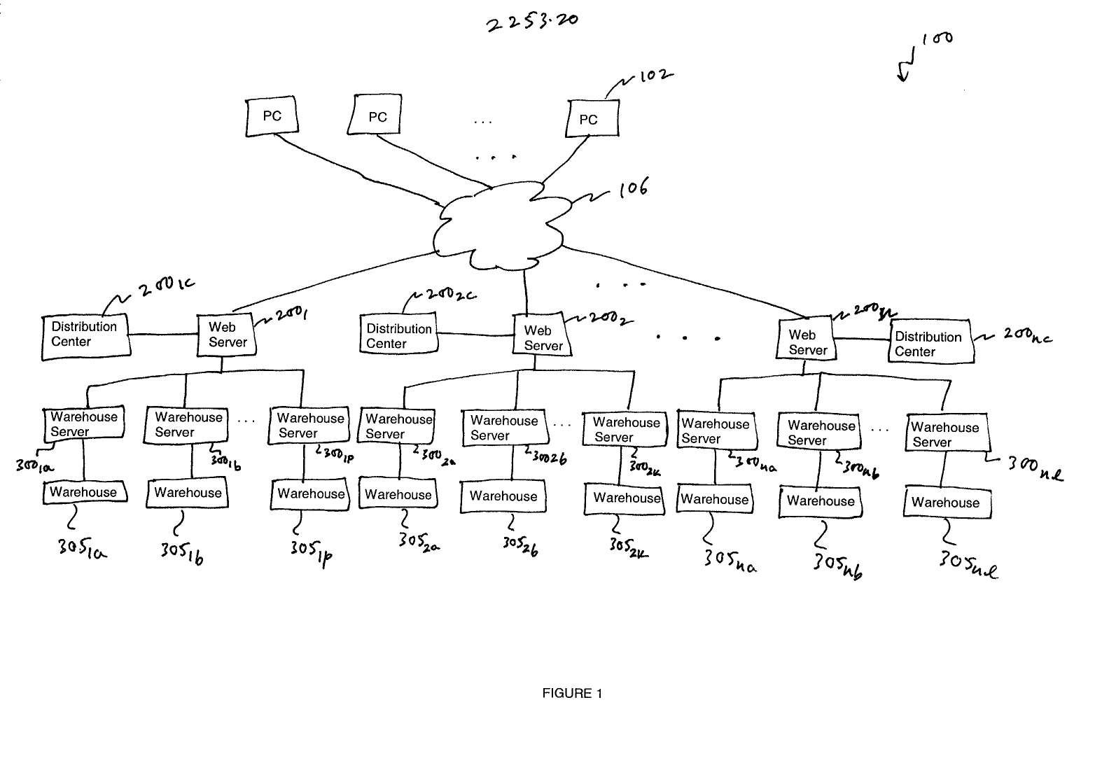

FIGS. 1 through 5 illustrate one example of a direct channel distribution and sales system that employs the teachings of the present invention and reveals its advantages. Like numerals being used for like and corresponding parts of the various FIGURES.

FIG. 5 is a schematic block diagram 500 illustrating a plurality of geographically distributed hubs according to the teachings of the present invention. As shown in FIG. 5, hubs may be set-up in different regions of the country or world to provide distribution services in the respective regions. Thus, as shown hub 502 serves region 503, hub 504 serves region 505, hub 506 serves region 507, and hub 508 serves region 509. Each of the hubs is communicatively connected to one or more of the other hubs. Moreover, as shown, hub 502 is the base hub for client business entity 501 which is located in the geographical area served by hub 502.

FIG. 1 is a schematic diagram of a preferred embodiment system for providing direct channel distribution. The system and method of the present invention are preferably implemented with a system broadly referred to by the number 100 in FIG. 1. The system is described and illustrated herein for purposes of disclosing a preferred embodiment of the invention and may be replaced with other conventional equipment without departing from the scope of the invention.

The preferred embodiment system 100 includes one or more client computer devices (e.g. processor based devices) 102, such as personal computers (PCs), workstations, laptop computers, personal data assistants (PDAs), wireless phones and/or the like, that may be used by a client/user, such as a representative of the business entity, a customer of the business entity, a representative at a distribution center, and/or the like. Computer device 102 may be a standalone device or multiple computers may be networked together via a communication network. In the preferred embodiment, the communications network 106 may comprise a public network, such as the Internet. In alternative embodiments, communications network 106 may comprise any means of information communication, such as PSTN, wireless communication network, a proprietary network, a general purpose processor-based information network, dedicated communication lines, a computer network, direct PC to PC connection, a local area network, a wide area network, modem to modem connection, an Intranet, an Extranet or any combination thereof suitable for providing information to and from client/user computer 102.

The client/user computer(s) 102 may be networked with one or more host computers 200₁, 200₂, . . . , 200ₙ, via communications network 106. Each of the host computers 200 preferably acts as a web server/interface and may also serve as a repository for certain data and programs as described in more detail below. Web server 200 may be any computing device, such as a network computer running Windows NT, Windows2000, Linux, Novell Netware, Unix, or any other network operating system.

In the preferred embodiment, each of the web servers 200 is preferably associated with one or more distribution centers. Thus, for example, web server 200₁ is associated with distribution center 200_{1c}, web server 200₂ is associated with a distribution center 200_{2c}, web server 200ₙ is associated with a distribution center 200_{nc} and so on. Although, in the preferred embodiment, each of the web servers is associated with a distribution center, the invention is not so limited and in alternative embodiments, one or more of the web servers may not be associated with a distribution center.

In the preferred embodiment, each of the web servers 200₁ through 200ₙ also includes conventional web hosting operating software and includes a device for connecting with a global computer network, for example, the Internet. Such a device could be for example, a modem, a cable modem, a wireless modem, a wireless gateway, a xDSL modem, or ISDN converter.

In the preferred embodiment, each of the web servers 200₁ through 200ₙ communicates with server(s) 300 at one or more warehouses 305. Thus, web server 200₁ communicates with one or more servers 300₁ₐ,300_{1b}, . . . 300₁ₚ; web server 200₂ communicates with one or more servers 300₂ₐ, 300_{2b}, . . . , 300₂ₖ; and web server 200ₙ communicates with one or more servers 300ₙₐ, 300_{nb}, . . . , 300ₙ₁. As shown, server 300₁ₐ is associated with warehouse 305₁ₐ, server 300_{1b} is associated with warehouse 305_{1b}, server 300₁ₚ is associated with warehouse 305₁ₚ, server 300₂ₐ is associated with warehouse 305₂ₐ, server 300_{2b} is associated with warehouse 305_{2b}, server 300₂ₖis associated with warehouse 305₂ₖ, server 300ₙₐ is associated with warehouse 305ₙₐ, server 300_{nb} is associated with warehouse 305_{nb}, and server 300ₙ₁ is associated with warehouse 305ₙ₁.

In the preferred embodiment, the web server(s) 200 communicate with warehouse server(s) 300 via a global computer network (not shown), such as the Internet. Warehouses 305 may be associated with particular business entities, such as particular manufacturers. If desired, the business entities may outsource the warehouse management function to third parties and the warehouses may be associated with these third parties.

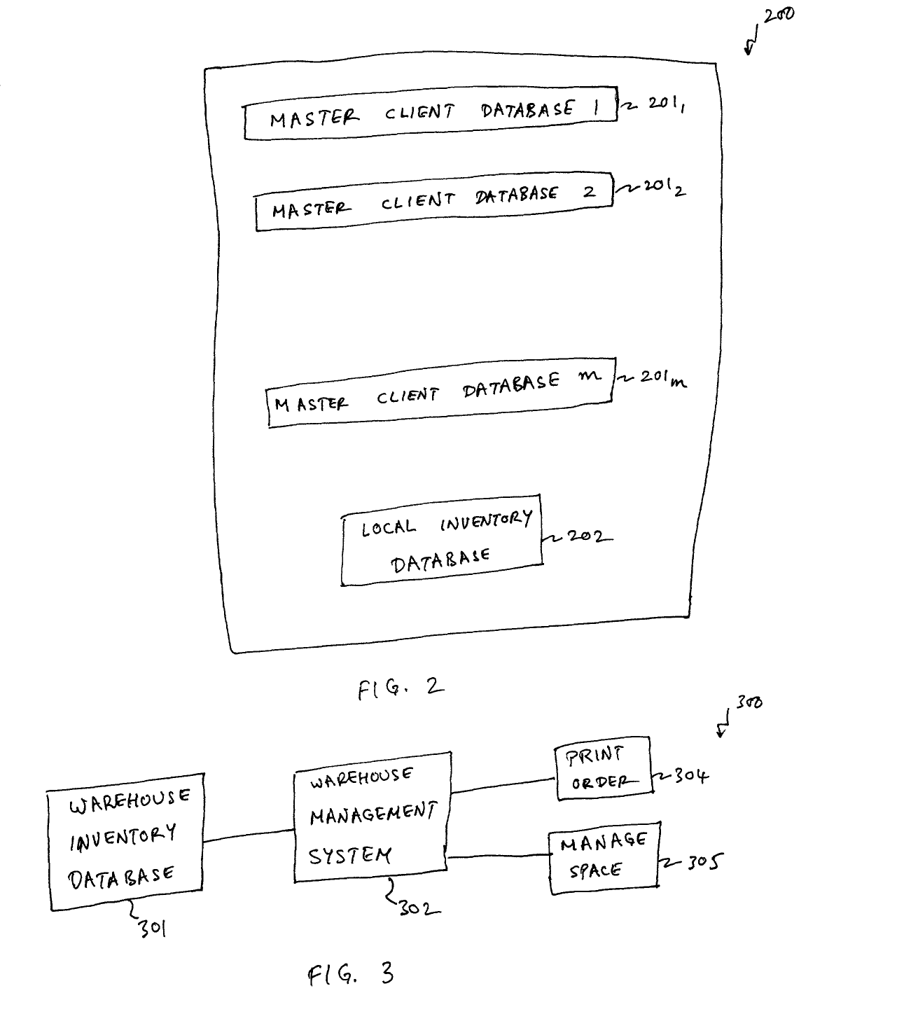

FIG. 2 is a schematic block diagram of a preferred embodiment web server 200. Web server 200 includes a master client database for one or more clients, such as business entities. In the preferred embodiment, web server 200 includes the master client database for those clients for whom the distribution center associated with the web server or the web server itself serves as the base hub. Thus, web server 200 may include a master client database 201₁ for client 1, a master client database 201₂ for client 2, and a master client database 201ₘ for client m. In the preferred embodiment, the master client database for a client includes information about the inventory for the particular client at all the warehouses around the world, including the warehouses associated with the particular web server. Thus, worldwide inventory information about a client can be accessed at the client's base hub server or base hub distribution center. The master client database also includes information, such as set-up information, business rules, orders, order history, shipping information, receiving records, destroy records and/or the like regarding the particular base hub client.

In the preferred embodiment, the interface to and/or presentation of information is localized. Accordingly, the business rules may be set-up to include information such as the preferred language to be used for a particular client, the preferred currency, the sales presentation to be made, duration of the sales presentation and/or the like depending on the geographical region. Thus, if a customer of a client in say, France calls a service center or accesses a web site, information may be presented to the customer of the client in French and using the local currency. In the preferred embodiment, the business rules may also be set up so that messages, such as product information, advertisements, sales presentations, may be displayed to the user upon the occurrence of certain events, such as when the user logs onto the web server or the user accesses the web site. The messages to be displayed to the user upon the occurrence of certain events may be customized depending on one or more factors, such as the business entity, the location of the user and/or the like.

Web server 200 preferably also includes one or more local inventory databases 202 for other clients. In the preferred embodiment web server 200 includes a local inventory database for those clients for whom the distribution center associated with the web server or the web server itself does not serve as the base hub. The local inventory database includes information about the inventory stored in the warehouses associated with the particular web server for non-base hub clients.

FIG. 3 is a schematic block diagram of a preferred embodiment server 300 at one or more distribution locations, such as one or more warehouses. Server 300 includes a warehouse inventory database 301. In the preferred embodiment, the warehouse inventory database includes information about all the inventory at a particular warehouse irrespective of client. Server 300 also includes a warehouse management system 302, a print order module 304, and a manage space module 305. Although in FIG. 3 the print module 304 and the manage space module 305 are shown as separate from the warehouse management system 302, the invention is not so limited and these may be part of the warehouse management system 302, if desired.

The warehouse management system 302 manages the warehouse inventory. Accordingly, the warehouse management system includes information such as expected shipments, expected inventory receipts, destruction of inventory, location of inventory within the warehouse, client information and/or the like associated with the inventory at a particular warehouse. The warehouse management system 302 interacts with the warehouse inventory database 301 and provides information to the warehouse inventory database about shipments, receipts and/or the like so that database 301 is updated. The print order module 304 prints the received orders preferably under the direction of the warehouse management system 302. The manage space module 305 manages the space at the warehouse.

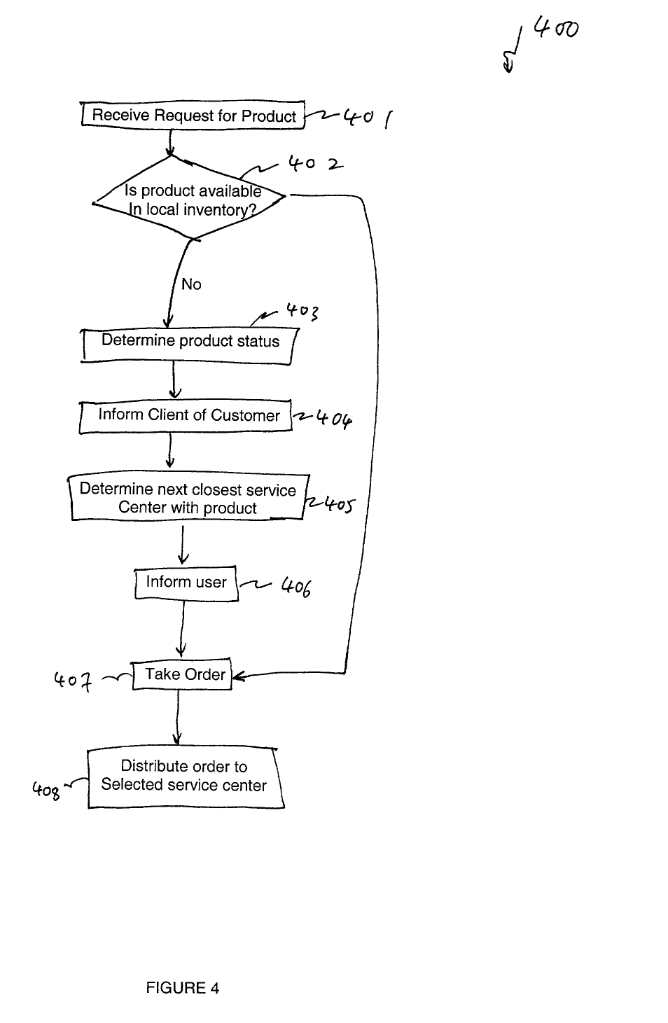

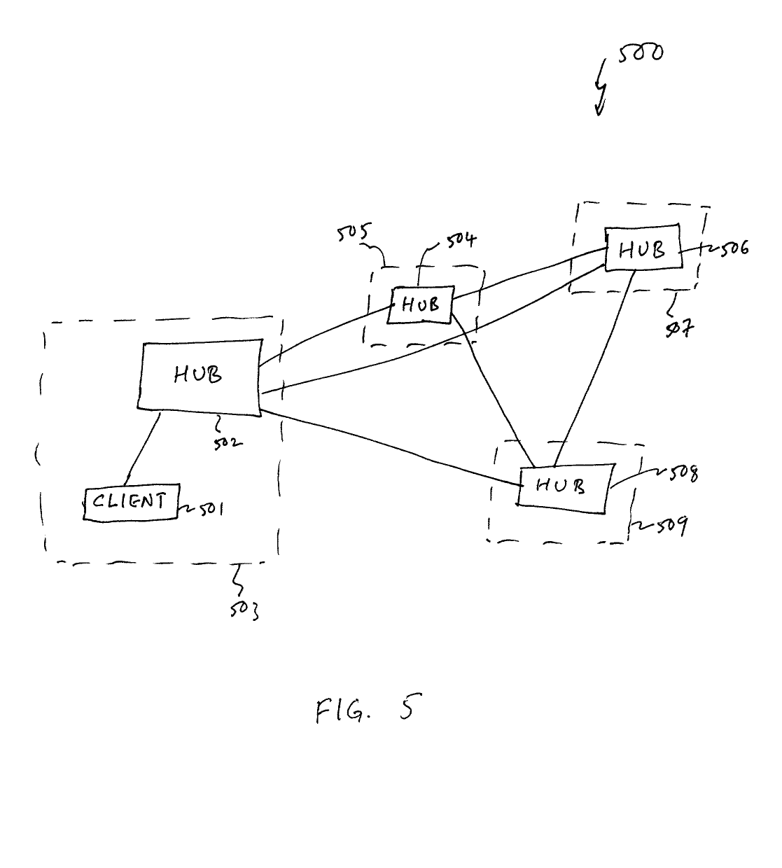

FIG. 4 shows a flowchart 400 for the preferred embodiment method for processing an order request. In step 401 a request for a product is received from a user. In the preferred embodiment, in order to place the order a user, for example a customer of a client accesses a web site of the client, preferably by logging in to a web server, for example server 200₁. In alternative embodiments, the customer may call a distribution center to place an order, such as distribution center 200_{1c} and a representative at the distribution center may log onto the server, e.g. server 200₁.

In the preferred embodiment, the distribution center called by the customer or the web site accessed by the customer is associated with the base hub for that particular business entity. In the preferred embodiment, the base hub for a particular business entity is located in a geographical region in which the headquarters of the business entity is located. A message, such as a sales presentation, may be made to the user in the local language. However, the web server may be located elsewhere. Order information is then collected from the user. Such information may include for example, a business entity identifier, a product number, number of units desired, and/or the like. For example, if the user is accessing a web site then the user is presented with a screen so that the user can enter order information. Upon receiving the order, information from the master client database for the particular business entity is retrieved. This information preferably indicates the particular format and/or language to be used for the particular business entity. For example, if the business entity is based out of France then the information including names of products, price and/or the like may be displayed to the user in French. Moreover, the price of the product may be displayed in the local currency. In the preferred embodiment, the master client database stores the data in different languages and upon determination of the particular language to be used in a particular case, the data associated with that language is retrieved and displayed to the user. Thus, the base hub may be localized for a particular base hub business entity.

In step 402, a determination is made as to whether the requested products are available in the local inventory associated with the particular hub. In the preferred embodiment, since the master client database includes information about the warehouses associated with the particular hub, the master client database is searched to determine if the requested products are available in the local inventory, i.e. in the inventory of the warehouses associated with that particular hub. If the requested products are available in the local inventory then in step 407 the order is accepted by the hub.

If the product is not currently available in the local inventory, then in step 403 the status of the product is determined. Such status may indicate, for example, that the product is being manufactured, the product will be available at the hub in say three days, and/or the like. In step 404, the status information is provided to the user preferably in the determined language. Thus, if the user is logged onto the web server, the status information is displayed to the user. If the user is talking to a sales representative, then the sales representative can inform the user about the status of the product.

In step 405 the next closest distribution center having an associated warehouse, if any, that has the requested product available is determined. In the preferred embodiment, this may be accomplished by accessing the inventory records of the next closest distribution center. Once the next closest distribution center is selected, a determination is made as to whether the requested product is available in a warehouse associated with the selected distribution center. In the preferred embodiment this is accomplished by communicating with the server associated with the selected distribution center, preferably via communications network 106, such as a global computer network, for example the Internet. If the product is not available at the selected distribution center then another distribution center is selected. This process is repeated until a distribution center with the requested product is found or there are no more distribution centers to search. In step 406, the user is informed if the requested product is found at a warehouse associated with another distribution center. Thus, if the user is logged onto the web server, information about the product including time for delivery, shipping costs and/or the like is displayed to the user. If the user is talking to a sales representative, then the sales representative can inform the user about the availability (or non availability) of the product at the other distribution centers, including the expected time for delivery, shipping costs and/or the like.

In step 407, the order is taken from the user. If the user is logged onto the web server, the user can place the order at the web site. If the user is talking to a sales representative, the sales representative can take the order from the user. Once the order is taken from the user, the inventory at the selected warehouse is subtracted so that the same portion of the inventory may not be allocated for multiple orders. Moreover, if the user changes its mind and decides to cancel the order, the inventory is updated to reflect the cancellation in the order. In the preferred embodiment, the warehouse management system at the selected server performs management of the inventory.

In step 408, the order is routed to the server associated with the warehouse that had been selected for fulfilling the order. In the preferred embodiment the order is routed to the server associated with the selected warehouse preferably over a global computer network, such as the Internet. A routing table with information about the different servers, such as server identifier, routing address, location and/or the like is included in the web server. Thus, by looking up the routing address of the selected server, the order can be routed to the selected server over the communications network. For example, the routing number of a server may be its IP address and the server identifier may be 1036TX1 for the first server in Texas, 1036TX2 for the second server in Texas, 1036CH1 for the first server in China and so on. Once the order is received at the warehouse, the staff at the warehouse pick the item, box it and then ship it to the destination address as described in detail below.

Since the warehouse inventory databases of the warehouses are updated in real-time, i.e. upon receipt or cancellation of an order or receipt of new products, these databases reflect the actual state of the inventory at any given time. In order to keep the master client database at the base hub servers current, information from the warehouse inventory database of various warehouses are provided to the master client database periodically. For example, for a particular client updated inventory information from the warehouse inventory databases at warehouses all over the world may be communicated to the base hub web server once a day, for example at night, in order to update the master client database for the client which is preferably located at the base hub web server. The frequency and timing of the update preferably depends on various factors, such as the business entity, the type of product, the demand for the product and/or the like. Moreover, updating of the database may be staggered for the different locations.

In the preferred embodiment, the local inventory database 202 in a web server includes information about the inventory for non-base hub clients in warehouses associated with the particular web server. In the preferred embodiment for non-base hub clients only the local database of a server is searched to determine the availability of a product. Thus, if the requested product is available in the local database then the order is taken and distributed to a warehouse associated with a particular distribution center. In such a case, the local inventory database is updated instantly. Therefore, in the preferred embodiment, the local inventory database reflects the actual state of the inventory at the local warehouses at any given time.

In the preferred embodiment, the present invention allows variable cost billing to a business entity. Thus, the business entity does not have to pay a fixed cost irrespective of the work performed at the various warehouses. Instead the cost to the business entity depends on the amount of work performed for the particular business entity at the various warehouses.

In the preferred embodiment, each task performed at a warehouse is assigned a specific selling rate per minute. The specific selling rate is preferably based on several factors, such as level of skill required to perform the task, labor costs for personnel, equipment costs, machinery costs, space within the warehouse, utility costs, for example, heat, light, air conditioning costs and/or the like. Moreover, if desired a rate per minute may be determined for equipment that can be operated without a personnel in attendance and the business entity charged based on the usage of such equipment.

In the preferred embodiment, all the time within a particular time frame, for example a month, a week, a day, and/or the like, for each operation is collected. The total time for each operation is then multiplied by its selling rate which may be the same for all operations or different depending on the operation. Moreover, the selling rate for each location is customized for that particular location and is preferably based on various factors, such as the currency used, cost of labor, cost of equipment and/or the like that is typical of that location. Invoices may be sent to the business entities periodically preferably electronically.

The advantage of the preferred embodiment method of billing as described above is that it allows variable costs billing. For each business entity the costs relate to the specific amount of material held in each of the warehouses plus the amount of different types of work performed during a period of time. Thus, different business entities can not only share warehouse space all over the world, but also share the expenses related to the personnel at the various locations, while at the same time paying only for the services performed on their behalf. A business entity who has only a few minutes of productive work performed at a warehouse on any given day only pays for those few minutes of work. Thus, a business entity pays only for the amount of labor or work performed to service its own needs. Variable cost billing can be used for as many locations as the business entity uses anywhere in the world.

A computerized system for time entry may be used to keep track of the time spent by the person(s) performing a specific task. A hand held device, such as a small computer having a wireless communication capability, can be used for this purpose, if desired. Thus, the hand held device can be used to keep track of time for the billing system, provide order tracking capabilities, and/or the like. Direct time system reporting for non-mobile personnel, such as personnel working at desks, can also be implemented.

Moreover, because the preferred embodiment method and system provides information to a business entity about its inventory in warehouses around the world the business entity can manage the direct channel sales and distribution of its products around the world using, for example a client server based computer, at the preferred location, for example the home location, of the business entity. The business entity can decide how much inventory to keep in any location at any given time, monitor the inventories at the different locations, give instructions for moving the inventory from one location to another and/or the like. Accordingly, the business entity may choose to have as many or as few items at any one location as meets the needs of the market served by that specific location. Thus, for example, the business entity can move a product from a slow moving market to a faster moving market making the worldwide business operations of the business entity more efficient.

Although in the preferred embodiment as described above non-base hubs can access only local inventory, for example, inventory at warehouses associated with the particular hub, the invention is not so limited and in alternative embodiments both the base hub and the non-base hub may access worldwide inventory information about any particular business entity, if desired.

Furthermore, different levels of security can be provided so that different types of users may access different portions of the various databases. For example, a particular user may be allowed to search the entire inventory of a particular business entity while a different user may only be allowed to search the local inventory of a particular business entity. Moreover, the security requirements of different business entities may be different and thus the different business entities may designate their own separate security features.

In one aspect, the present invention allows performance of services and tracking of business activity at multiple locations. Thus, direct channel sales and distribution services, can be provided worldwide using a network of facilities to serve business entities on an outsourcing basis. One or more services needed to act in an outsourcing mode can be provided at a lower cost to a business entity than it would cost the business entity to establish such facilities and perform the work themselves.

As discussed in detail above, the system connects multiple locations using servers that preferably have their own unique localized “front end” characteristics. The front-end may be localized, if desired, to handle the differences in currency, language, culture, laws and/or the like in different regions of the world. While these customizations of the front-end designed to meet the needs of a specific marketplace, can be supported in a reasonably flexible way, the system preferably maintains its basic feature of connectivity to the Internet so that the different locations are networked into a direct channel sales and distribution system.

While the invention has been particularly shown and described by the foregoing detailed description, it will be understood by those skilled in the art that various other changes in form and detail may be made without departing from the spirit and scope of the invention.

What is claimed is:

1. A method, comprising:
establishing a warehouse in a selected geographical region;
receiving and storing inventory from a plurality of different business entities at said established warehouse;
charging said plurality of business entities for said storage based at least in part on actual storage space used by said business entity, wherein said one or more business entities are based in remote geographical regions; and
providing on-demand access to inventory information at said warehouse to at least one of said one or more business entities.

2. The method of claim 1, wherein said on-demand access is provided via a global computer network.

3. The method of claim 2, wherein said global computer network is the Internet.

4. The method of claim 3, further comprising:
receiving and storing inventory for said plurality of business entities at a second warehouse; and
providing on-demand access to inventory information at said first warehouse and said second warehouse to at least one of said plurality of business entities.

5. The method of claim 1, wherein said providing step comprises:
tracking inventory at said warehouse for said plurality of business entities;
allowing said plurality of business entities to access said tracked inventory information via a global communications network; and
displaying information to said plurality of business entities.

6. The method of claim 5, wherein said displayed information includes information selected from the group consisting of said tracked inventory information, accounts payable information, and accounts receivable information.

7. The method of claim 6, wherein said displayed information is customized based at least in part on the geographical location of said business entity.

8. The method of claim 6, wherein said displayed information is customized based at least in part on said selected geographical region.

9. The method of claim 1, wherein said warehouse serves as a base hub for one or more business entities located in said selected geographical region.

10. The method of claim 9, wherein said hub includes a database of worldwide inventory of said one or more business entities.

11. The method of claim 2, further comprising providing one or more business services to said one or more business entities from said warehouse on an outsourcing basis.

12. The method of claim 11, wherein said one or more business services include telemarketing services.

13. The method of claim 11, wherein said one or more business services include variable cost billing services.

14. The method of claim 11, wherein said one or more business services include shipping services.

15. The method of claim 11, wherein said one or more business services include sales services.

16. The method of claim 11, wherein said one or more business services include fulfilling orders for materials.

17. The method of claim 16, wherein said orders are accepted via said global computer network.

18. The method of claim 17, further comprising presenting a customized front end for controlling flow of said materials through said warehouse.

19. The method of claim 18, wherein said customization of said front end is based at least in part on said selected geographical location.

20. The method of claim 18, wherein said customization is based at least in part on the location of a user accessing said customized front end.

21. The method of claim 19, wherein said customization comprises presenting information to said user in a language local to said selected geographical location.

22. The method of claim 21, wherein said presented information includes a sales presentation.

23. The method of claim 19, wherein said customization comprises presenting price information to said user for an order comprising said material in a currency local to said selected geographical region.

24. The method of claim 19, wherein said customization comprises presenting price information to said user for an order comprising a material at a different geographical region in a currency local to said different geographical region.

25. A method of inventory management over a global computer network, comprising:
receiving a request for a product of one or more business entities at a web server;
determining on-demand the availability of said product in one or more warehouses associated with said web server;
communicating with another server associated with another warehouse over a global computer network to determine on-demand the availability of said product at said another warehouse, if said product is not available at said one or more warehouses; and
accepting an order for said product at said web server.

26. The method of claim 25, wherein said web server is associated with a distribution center and said distribution center has said one or more warehouses associated with it.

27. The method of claim 25, wherein said request for said product is received from a user accessing said web server via a web browser.

28. The method of claim 25, wherein said request for said product is received from a representative at a distribution center.

29. The method of claim 25, wherein said web server is a base hub for a business entity providing said requested product.

30. The method of claim 29, wherein said request for said product includes a product number for said product and the number of units of said product.

31. The method of claim 27, further comprising:
displaying a sales presentation to said user prior to receiving said request from said user, wherein said sales presentation is customized based on the location of said first web server.

32. The method of claim 27, further comprising:
displaying a sales presentation to said user prior to receiving said request from said user, wherein said sales presentation is customized based on the location of said user.

33. The method of claim 27, further comprising:
presenting information to said user about said product, wherein said information is customized based on the location of said web server.

34. The method of claim 33, wherein said information is presented to said user in a language that is commonly used at the location of said web server.

35. The method of claim 33, wherein said information presented to said user includes the price of said product, wherein said price is displayed to said user in a currency that is commonly used at the location of said web server.

36. The method of claim 33, wherein said presenting information step further comprises:
storing information in a database associated with said web server in different formats;
determining a particular format in which to present said stored information; and
retrieving said stored information in said particular format for presentation to said user.

37. The method of claim 26, wherein said communicating step comprises:
selecting another distribution center; and
communicating with said selected distribution center to determine if said product is available at one or more warehouses associated with said selected distribution center.

38. The method of claim 25, wherein said order includes a product identifier and the number of units for said product.

39. The method of claim 25, further comprising:
selecting a warehouse from the group consisting of said one or more warehouses and said another warehouse for fulfilling said accepted order.

40. The method of claim 39, wherein said accepted order includes a product identifier and a number of units of said product.

41. The method of claim 40, further comprising:
subtracting said number of units of said product from an inventory of said selected warehouse; and
communicating said accepted order to said selected warehouse via said global computer network.

42. The method of claim 41, further comprising:
fulfilling said communicated order at said selected warehouse.

43. The method of claim 42, wherein said fulfilling step comprises:
picking at least said number of units of said product associated with said order; and
packing said number of units of said product for shipping.

44. The method of claim 25, wherein said global computer network is the Internet.

45. The method of claim 37, further comprising:
providing information about the inventory of said one or more warehouses associated with said selected distribution center periodically to said web server associated with said first distribution center to update inventory information in said web server associated with said first distribution center.

46. A system for inventory management over a global computer network, comprising:
a web server including a master client database and a local inventory database, wherein said web server receives a request for a product from a customer wherein said master client database includes information relating to the inventory of a particular client at a plurality of its warehouses, including the warehouses with which said local servers are associated.; and
one or more local servers associated with said web server, wherein said one or more local servers and said web server are geographically distributed, wherein each of said local servers is associated with a warehouse and includes a warehouse inventory database, wherein said web server communicates with said local servers via a global communication network, and wherein inventory information can be assessed on-demand by said client.

47. The system of claim 46, wherein said master client database further includes information selected from the group consisting of set-up information, business rules, orders, order history, and shipping information regarding said particular client.

48. The system of claim 46, wherein said local inventory database includes information relating to the inventory of another client, wherein said inventory is located at the warehouses with which said local servers are associated.

49. The system of claim 46, wherein upon receiving said request from said customer, said master client database is searched to determine if said product is available at the warehouses with which said local servers are associated.

50. The system of claim 48, wherein upon receiving said request from said customer, said local inventory database is searched to determine if said product is available at the warehouses with which said local servers are associated.

51. The system of claim 46, wherein said web server is associated with a distribution center.

52. The system of claim 49, further comprising:
a second web server including another master client database and another local inventory database, wherein said first web server communicates with said second web server via a global computer network.

53. The system of claim 52, wherein said second web server is associated with a second distribution center.

54. The system of claim 53, further comprising:
one or more local servers associated with said second web server wherein each of said local servers is associated with a warehouse.

55. The system of claim 54, wherein said one or more local servers is searched to determine if said product is available at a warehouse associated with said one or more local servers.

56. A computer program product having a computer readable medium with computer program logic recorded thereon for use in a system for inventory management over a global computer network, said computer program product comprising:
code for receiving a request for a product at a web server;
code for determining on-demand the availability of said product in one or more warehouses associated with said web server;
code for communicating with another server associated with another warehouse over a global computer network to determine on-demand the availability of said product at said another warehouse, if said product is not available at said one or more warehouses; and
code for accepting an order for said product at said web server.

57. The computer program product of claim 56, wherein said web server is a base hub for a business entity providing said requested product.

58. The computer program product of claim 57, wherein said request for said product includes a product number for said product and the number of units of said product.

59. The computer program product of claim 56, wherein said request for said product is received from a user accessing said web server via a web browser.

60. The computer program product of claim 59, further comprising:
code for presenting information to said user about said product, wherein said information is customized based on the location of said web server.

61. The computer program product of claim 60, wherein said code for presenting information further comprises:
code for storing information in a database associated with said web server in different formats;
code for determining a particular format in which to present said stored information; and
code for retrieving said stored information in said particular format for presentation to said user.

62. The computer program product of claim 56, further comprising:
code for selecting a warehouse from the group consisting of said one or more warehouses and said another warehouse for fulfilling said accepted order.

63. The computer program product of claim 62, wherein said accepted order includes a product identifier and a number of units of said product.

64. The computer program product of claim 63, further comprising:
code for subtracting said number of units of said product from an inventory of said selected warehouse; and
code for communicating said accepted order to said selected warehouse via said global computer network.

65. The computer program product of claim 64, wherein said communicated order is fulfilled at said selected warehouse.

66. The computer program product of claim 56, wherein said global computer network is the Internet.

67. The computer program product of claim 56, further comprising:
code for providing information about the inventory of said one or more warehouses associated with said selected distribution center periodically to said web server associated with said first distribution center to update inventory information in said web server associated with said first distribution center.
